(19) United States
(12) Patent Application Publication
(10) Pub. No.: US 2015/0298331 A1
(43) Pub. Date: Oct. 22, 2015

(54) METHOD AND APPARATUS FOR SUPPORTING PRODUCT DURING CUTTING

(71) Applicant: Paper Converting Machine Company, Green Bay, WI (US)

(72) Inventors: Eric P. Diehr, De Pere, WI (US); Cory P. Gussert, Pulaski, WI (US)

(21) Appl. No.: 14/755,233

(22) Filed: Jun. 30, 2015

Related U.S. Application Data
(62) Division of application No. 13/312,652, filed on Dec. 6, 2011.

(51) Int. Cl. B26D 1/56; B26D 7/01

(52) U.S. Cl. CPC B26D 1/56; B26D 7/01

(57) ABSTRACT

Elongated product is cut while the product moves longitudinally by a cutting blade which passes through the product and which also moves longitudinally with the product. The product is supported by first and second product supports which are spaced apart in the longitudinal direction to provide a gap through which the cutting blade passes. The product supports are mounted for movement in the longitudinal direction and move longitudinally as the cutting blade passes through the gap.

### RELATED APPLICATION

This application is a divisional application of co-pending U.S. patent application Ser. No. 13/312,652, filed Dec. 6, 2011, entitled Method and Apparatus for Supporting Product During Cutting, the priority of which is claimed under 35 U.S.C. §§120 & 121.

### BACKGROUND

This invention relates to a method and apparatus for supporting product during cutting, and more particularly, to supporting product for cutting by a saw which transversely severs material such as a log of convolutely wound bathroom tissue or kitchen toweling in single or multiple lanes, rolls of wipes material, and the like.

In the production of rolls of bathroom tissue, kitchen toweling, or wipes, a jumbo sized parent roll of web material is unwound and rewound into an elongated log which has the diameter of the final product. The log is cut into individual rolls of bathroom tissue, kitchen toweling, or wipes by a saw. When the individual rolls are produced, two end trim pieces are also produced since the lengths of the log are variable due to variations in width of jumbo size parent rolls and the rewinding process. The ends of the logs need to be cut off straight and perpendicular to the axis of the log. The ends are present when the log length is longer than an even multiple of the number of rolls cut therefrom. Typical end trim cuts are approximately 1.0 to 3.0 inches in length and are waste in the production.

Log saws are described, for example, in U.S. Pat. No. 6,123,002, U.S. Pat. No. Re. 30,598, U.S. Pat. No. 5,799,555, and U.S. Pat. No. 8,037,794

In most present log saw assemblies, the elongated log is advanced longitudinally or axially toward the path of the blade, which passes generally transversely through the log. The log is supported upstream of the blade, and the cut rolls plus the roll which is being cut are supported downstream of the blade.

The problems with current log saws vary depending upon the saw. In some designs the conveyor for the log intermittently advances the log through the saw, and the log is stopped during cutting. U.S. Pat. No. 5,647,259 illustrates a log support for an intermittent motion log saw. The log support is rigid and provides a narrow opening parallel to the path of the blade. This narrow opening allows the support to provide additional support of the log during cutting. Saws that intermittently advance the log cut the log at a lower rate due to cutting the log while it is stopped.

In other designs of log saws, e.g., as is shown in U.S. Pat. No. 5,799,555, the log is moving longitudinally or axially during cutting, and the blade also moves longitudinally or axially with the log during the cutting process as the blade moves generally transversely through the log. Again, the log support, which is generally called a clamp, is rigid, but the opening between the upstream and downstream support assemblies forms a “V” to provide clearance for the path of the axial movement of the blade. See particularly FIGS. 7 and 8. The clamp confines and therefore supports the log during cutting. However, the clamp does not compress the log sufficiently to prevent longitudinal movement of the log through the clamp. A similar clamp or product support is described in U.S. Pat. No. 5,357,833.

In U.S. Pat. No. 5,799,555 the blade is mounted for rotation on an axis which is parallel to the axis of movement of the log and moves generally transversely through the log to cut the log while also moving axially in a path which is parallel to the axial movement of the log. The wider V-shaped opening of the product suppport requires a wider end trim cut to be taken to provide adequate support of the product versus the prior indexing saws. If the trim width is too narrow and there is not enough support for the end of the log, the first cut will not be straight or perpendicular to the axis of the log.

U.S. Pat. Nos. Re. 30,598 and 6,123,002, which are co-owned by applicants' assignee, also describe a continuous motion saw in which the log moves axially while it is being cut. However, in U.S. Pat. Nos. Re. 30,598 and 6,123,002 a pair of blades are mounted for orbiting movement on an orbiting axis which is skewed relative to the axial movement of the log. As each blade passes through the log, the blade has both transverse and axial components of motion relative to the log. The axial component of motion of the blade matches the axial movement of the log.

U.S. Pat. No. 8,037,794 describes another continuous motion saw which is similar to the saw of U.S. Pat. No. 5,799,555 but which includes two pairs of axially spaced blades which are mounted for orbiting movement.

Continuous motion saws cut logs into rolls at a higher rate, but provide reduced log support because of the need to provide clearance for the axial movement of the blade. This reduced support can result in lower quality end rolls when end trim pieces are shorter and can also affect the quality of the cut rolls intermediate the ends of the log.

As shown in U.S. Pat. No. 6,332,527 and Int. Pub. No. WO 01/62454 A1, saws that cut the end trim pieces may also remove the end trim pieces adjacent to the cutting area.

In still other designs, as shown in U.S. Pat. No. 3,213,731, the saw is adapted to cut the log which has been previously cut to the exact length of an integral number of the individual rolls. To cut the log to the exact length, a separate module from the saw is used. The separate module, as is shown in U.S. 2006/0107805 A1 and EP 1 539 440 B1, is capable of cutting shorter or longer end trim pieces as previously described for intermittent or continuous motion saws. The module creates the need for additional floor space for the equipment, two additional saw blades for sharpening and maintenance, and two end trim piece removal locations.

### SUMMARY OF THE INVENTION

The invention solves the problem of requiring a wide end trim length of a log in a saw that cuts longitudinally moving elongated product into individual rolls, improves both the end cut and center cut quality, and reduces waste by narrowing the required parent roll width or by allowing an additional product to be cut from the elongated log. End trim cuts can be reduced to a smaller length, such as 0.5 inch on many products, with better or equal quality to cut products.

The inventive method and apparatus for supporting product during cutting provides axially movable upstream and downstream supports for the log close to the path of the blade, in particular while cutting the end trim pieces, using a continuous motion saw. The method and apparatus are suitable for use with all of the foregoing continuous motion saws, particularly those described in U.S. Pat. Nos. 5,799,555, Re. 30,598, 6,123,002, and 8,037,794. The method and apparatus allows the saw to cut shorter end trim pieces at a higher speed while providing good support for the cut rolls adjacent to the end trim pieces. The invention also optionally allows the axially movable product supports to be:

1. at a greater distance from the path of the blade when cutting longer end trim pieces;

2. close to the path of the blade when not cutting the end trim pieces;

3. at a greater distance from the path of the blade when not cutting the end trim pieces; and/or

4. closer to the blade around the product.

As the V-shaped opening of prior art clamps which allows clearance for the blade to enter and exit while axially moving forward is no longer required in the invention, the product support can be designed to provide full support around the product. The end of the product support near the blade can be parallel to the saw blade, providing the best possible support around the entire log.

Further, the upstream and downstream product supports can be at an equal distance from the path of the blade or at different distances from the path of the blade.

In a multiple lane saw, the product supports for each lane or each set of lanes can be close to or at a greater distance from the path of the blade, and the upstream and downstream product supports for each lane or set of lanes can be at an equal or non-equal distance from the path of the blade.

In the preferred embodiment of the invention, each lane of a multiple lane saw includes an upstream product support and a downstream product support which are slidably mounted for reciprocal movement along the path in which the log is advanced, i.e., parallel to the axial or longitudinal movement of the log. The path of the blade extends through a gap between the upstream and downstream product supports, and the product supports move axially in a downstream direction during cutting to accommodate the movement of the blade in the axial direction. The movement of each product support for each lane or each set of lanes is preferably independently controlled so that the spacing between the product supports of each lane or each set of lanes and the spacing of each product support from the blade may be controlled as desired.

### DESCRIPTION OF THE DRAWINGS

The invention will be explained in conjunction with an illustrative embodiment shown in the accompanying drawings, in which:

FIG. 1 is a side elevational view of a prior art product support or clamp for a log saw in which the blade is mounted for orbiting movement about an axis which is skewed with respect to the axis of the log;

FIG. 2 is a perspective view of a product support assembly formed in accordance with the invention which illustrates four sets of movable product supports upstream and downstream of the path of the cutting blade and a gap between the upstream and downstream product supports for allowing the blade to pass through the product supports and the product;

FIG. 3 is a view similar to FIG. 2 which also shows the troughs or channels for supporting four lanes of product;

FIG. 4 is a top plan view of FIG. 3;

FIG. 5 is a side elevational view of FIG. 2;

FIG. 6 is a bottom plan view of FIG. 3;

FIG. 7 is an end elevational view taken along the line 7-7 of FIG. 5;

FIG. 8 is an end elevational view taken along the line 8-8 of FIG. 5;

FIG. 9 is an exploded perspective view of a pair of upstream product supports;

FIGS. 10-12 are side elevational views which illustrate the axial movement of the upstream and downstream product supports and the cutting blade when the gap between the product supports is relatively narrow;

FIGS. 13-15 are views similar to FIGS. 10-12 when the gap between the product supports is relatively wide;

FIG. 16 is an enlarged side elevational view similar to FIG. 5 which illustrates a relatively narrow gap between the product supports and also shows the uncut log upstream of the blade and cut rolls plus a shorter end trim piece downstream of the blade;

FIG. 17 is a side elevational view similar to FIG. 16 showing the gap between the upstream and downstream product supports having a greater dimension than the gap in FIG. 16 and also showing the uncut log upstream of the blade and cut rolls plus a longer end trim piece downstream of the blade; and

FIGS. 18 and 19 are a side elevational views of a pair of four bar linkages for moving the product supports.

### DESCRIPTION OF SPECIFIC EMBODIMENTS

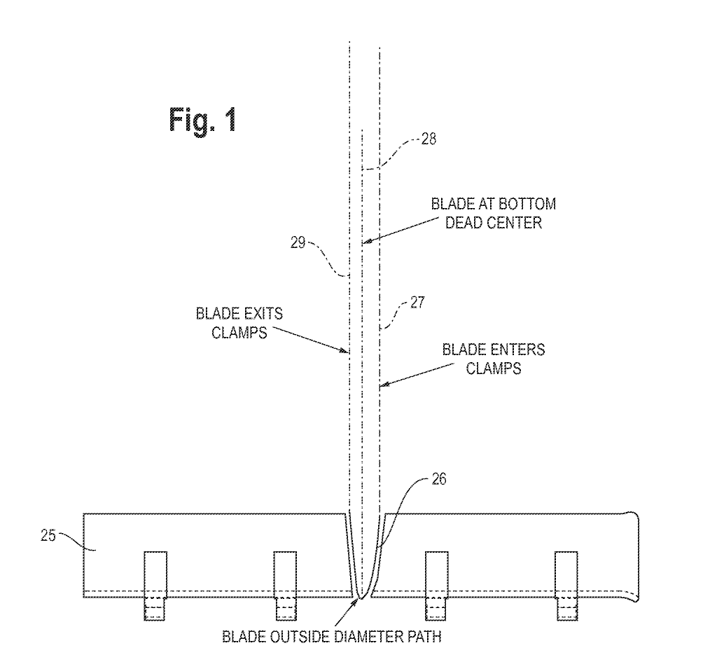

FIG. 1 illustrates a prior art product support or clamp 25 which has been used with continuous motion log saws of the type which are described in U.S. Pat. Nos. Re. 30,598 and 6,123,002. An elongated product (not shown), e.g., a log of toilet paper or kitchen towel, is advanced longitudinally over the product support from right to left. The product support is provided with a generally V-shaped notch 26. The movement of a cutting blade of a log saw is represented by the dashed lines 27, 28, and 29, which trace the movement of the outside diameter of the cutting blade. The blade passes generally transversely through the product while the blade also moves in the longitudinal direction of the moving product so that the blade moves longitudinally at the same speed as the product. The line 27 represents the path of the cutting blade as it enters the product and the V-shaped notch 26 and moves longitudinally to the left. The line 28 represents the position of the cutting blade at its bottom dead center, which is the farthest downward point of its downward transverse movement through the product. The line 29 represents the path of the cutting blade as it continues its longitudinal movement and is withdrawn from the product. The product support or clamp 25 remains stationary throughout the cutting process, and the V-shaped notch 26 accommodates the movement of the cutting blade in the longitudinal direction. However, the wide portion of the V-shaped notch reduces the support of the log during cutting. Additional description of the longitudinal and transverse movement of the cutting blade of continuous motion log saws of this type may be found in U.S. Pat. No. 5,289,747.

Similar prior art clamps or product supports for log saws are described in U.S. Pat. Nos. 5,357,833, 5,647,259, and 6,532,851.

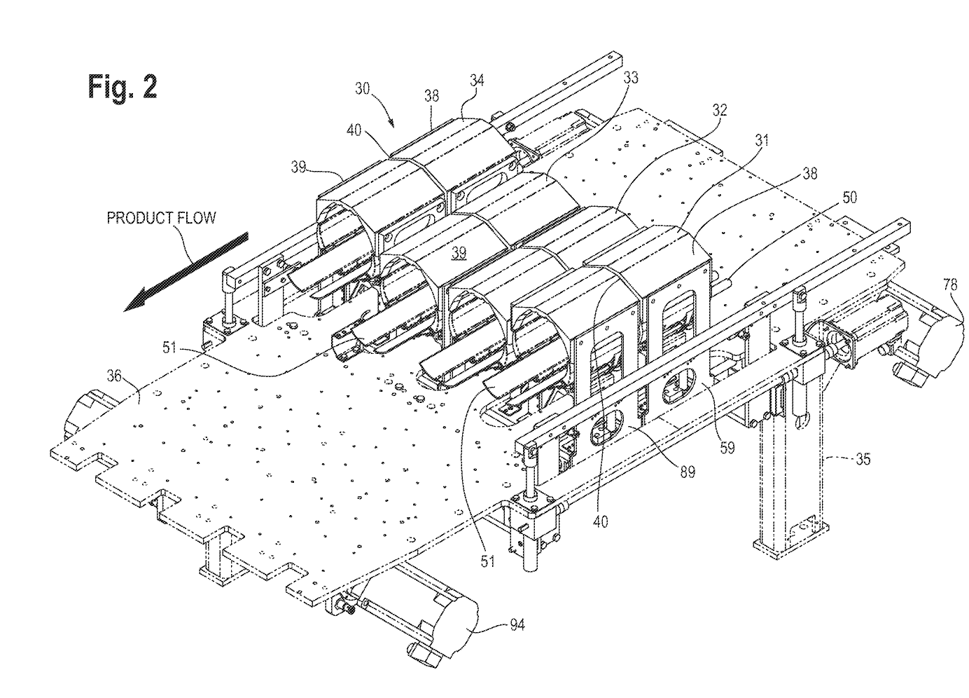

FIG. 2 illustrates a product support assembly or clamp assembly 30 which is formed in accordance with the invention. The particular product support which is illustrated is for use with a four lane log saw in which four parallel lanes of elongated products are advanced through the saw and cut by each pass of the cutting blade of the saw. The product support assembly thus includes four movable product supports or clamps 31, 32, 33, and 34 which are spaced apart transversely across the four lanes of product. It will be understood, however, that the invention is suitable for use with log saws having any number of product lanes.

The product support assembly 30 includes a stationary frame 35 which includes a flat stationary plate 36. The four product supports 31-34 are slidably mounted on the frame for reciprocating forward and backward movement along the longitudinal or axial direction in which the four lanes of products flow. Each of the movable product supports 31-34 includes an upstream support 38 and a downstream support 39 which are spaced apart to provide a gap 40 through which the cutting blade of the log saw passes to cut the products which are supported by the product supports.

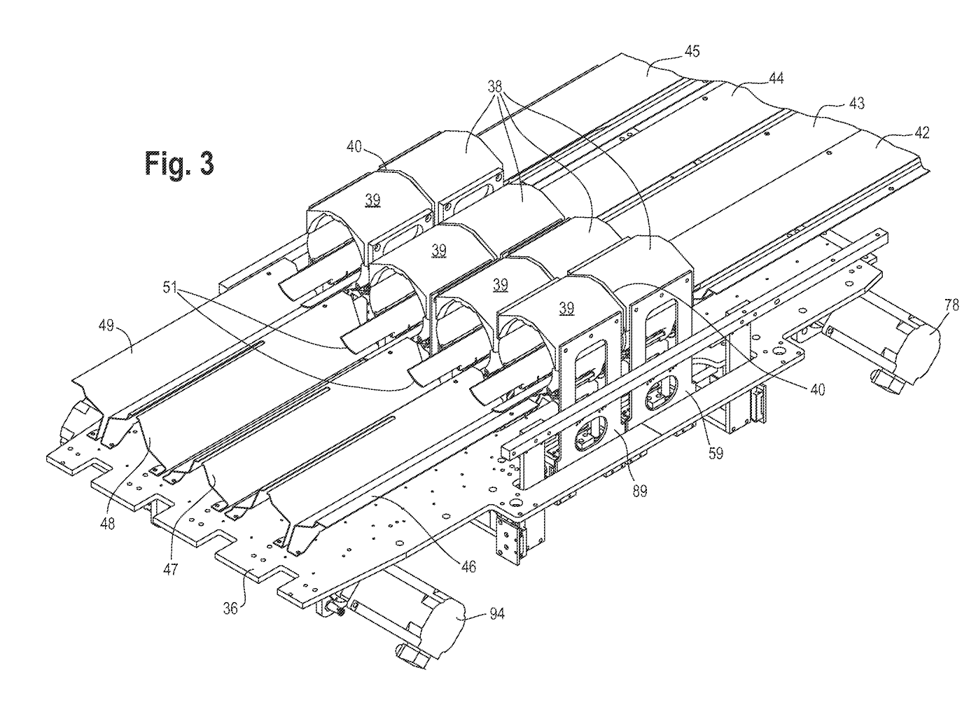

FIG. 3 is a view similar to FIG. 2, but FIG. 3 includes four elongated upstream stationary channels or troughs 42, 43, 44, and 45 and four elongated downstream stationary channels or troughs 46, 47, 48 and 49. The channels are mounted on the stationary plate 36. The upstream channels 42-45 support the elongated products before cutting, and the downstream channels 46-49 support the short cut products after cutting.

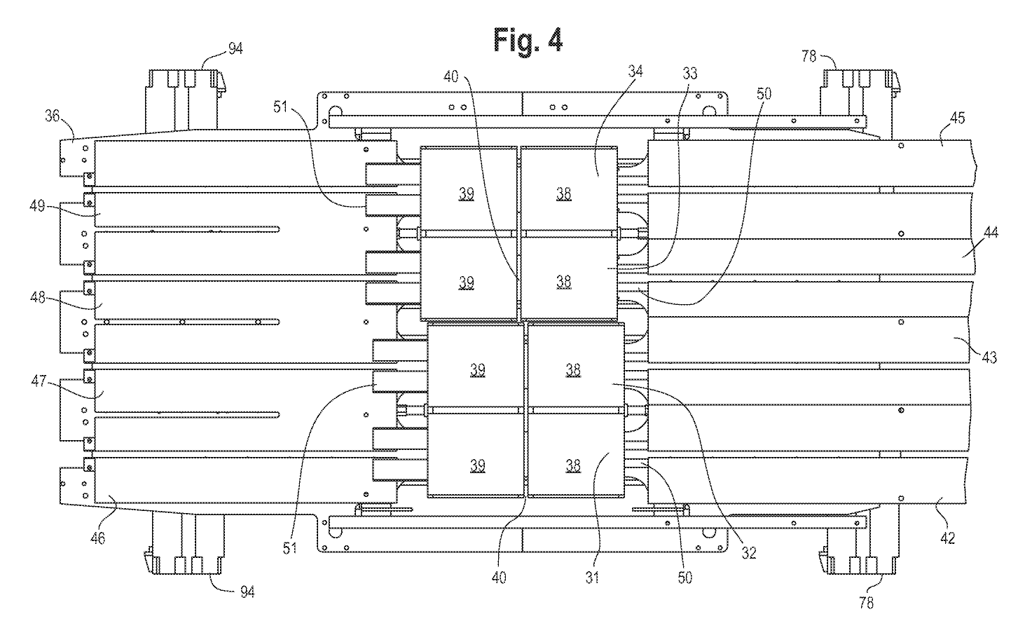

Referring to FIG. 4, in the particular embodiment illustrated, the product supports 31 and 32 for the first two lanes of product are connected for common reciprocating movement along the longitudinal direction of product flow. The gaps 40 of the product supports 31 and 32 are generally aligned. Similarly, the product supports 33 and 34 for the third and fourth lanes of product are connected for common reciprocating movement, and the gaps 40 thereof are generally aligned. It will be understood, however, that each of the product supports can be mounted individually for independent reciprocating movement or that more than two product supports can be connected for common reciprocating movement.

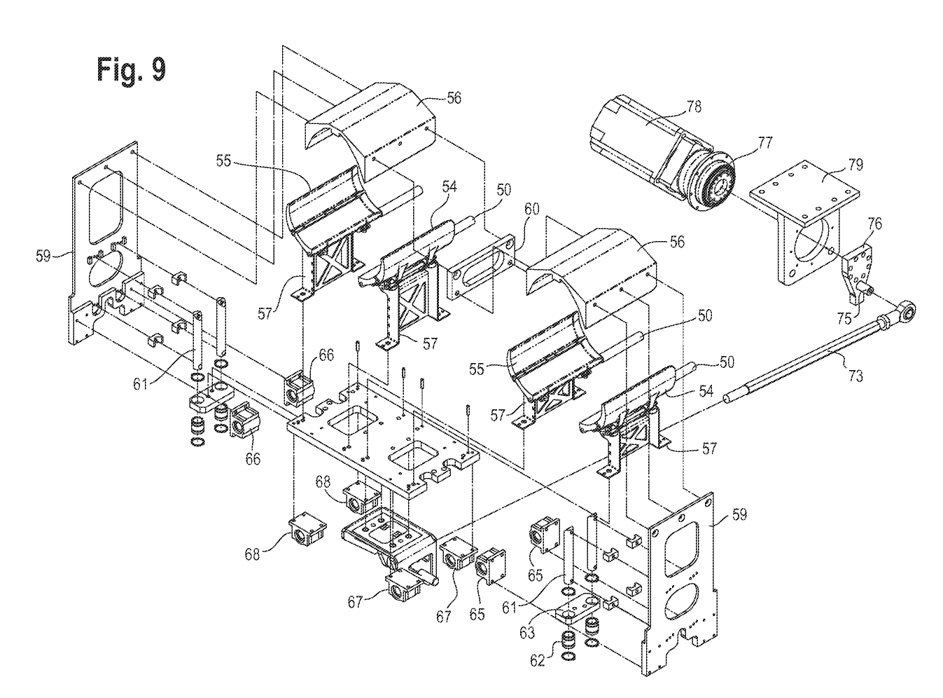

A pair of upstream entry rods 50 (see also FIGS. 2 and 9) extend to the right from each of the upstream product supports 38 for supporting the product as it moves from one of the stationary upstream channels 42-45 into the movable product support. The rods 50 slide under the channels 42-45 as the product supports reciprocate. A pair of downstream exit tongues 51 extend to the left from each of the downstream product supports 39 for supporting the cut products as they move from the movable product supports onto the stationary downstream channels 46-49. The tongues slide over the downstream channels 46-49 as the product supports reciprocate.

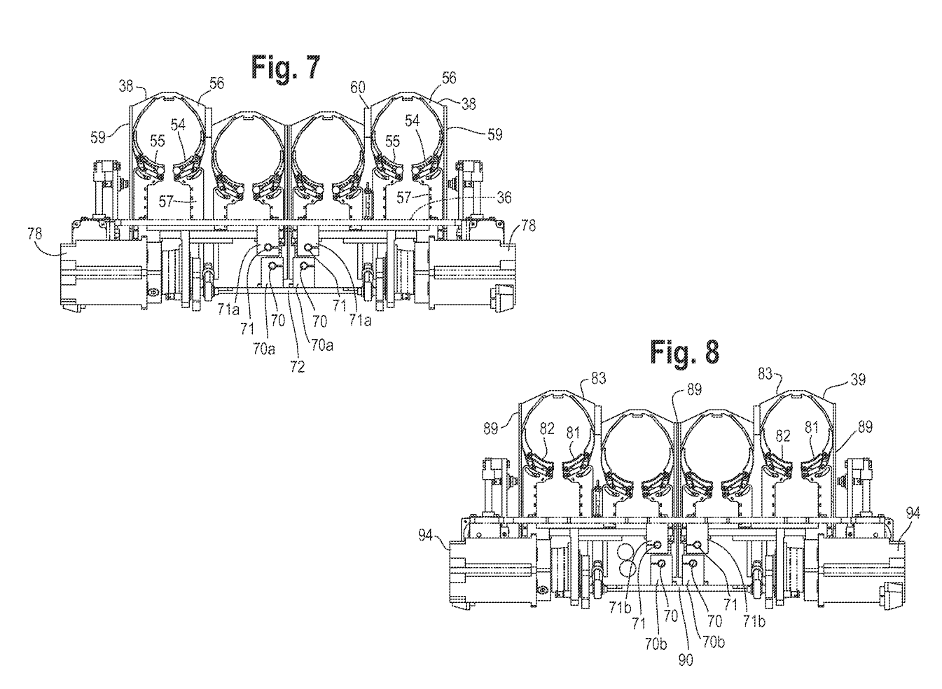

Referring to FIGS. 7 and 9, each of the upstream product supports 38 includes a pair of curved adjustable bottom clamps 54 and 55 and a curved top clamp 56. The top and bottom clamps can be formed in accordance with U.S. Pat. No. 6,532,851. Each of the bottom clamps is attached to a support bracket 57 which extends downwardly through and opening in the stationary plate 36 and is secured to a mounting plate 58. One side of the top clamp is secured to a side support 59 which extends downwardly past one side of the plate 36, and the other side is secured to a spacer 60. The height of the top clamp can be adjusted by adjusting rods 61 which are attached to each side support 59 and which extend through linear bearings 62 which are mounted in bearing housing 63.

The pair of upstream product supports 38 which are illustrated in FIG. 9 are slidably supported for longitudinally reciprocating movement by pillow block bearings 65 and 66 which are secured to the right and left side supports 59 for the top clamps 56 and by pillow block bearings 67 and 68 for the bottom clamps 54 and 55 which are secured to the mounting plate 58. The bearings 65 and 66 for each top clamp 56 slide over a pair of lower rods 70 (FIG. 7) which are mounted on the frame 35 by upstream locking blocks 70a which are attached to upstream tie bar 72 (FIG. 7) and by downstream locking blocks 70b (FIG. 8) which are attached to downstream tie bar 90. The bearings 67 and 68 for the bottom clamps slide over a pair of upper rods 71 which are mounted on the frame by upstream locking blocks 71a (FIG. 7) and downstream locking blocks 71b (FIG. 8) which are attached to the stationary plate 36.

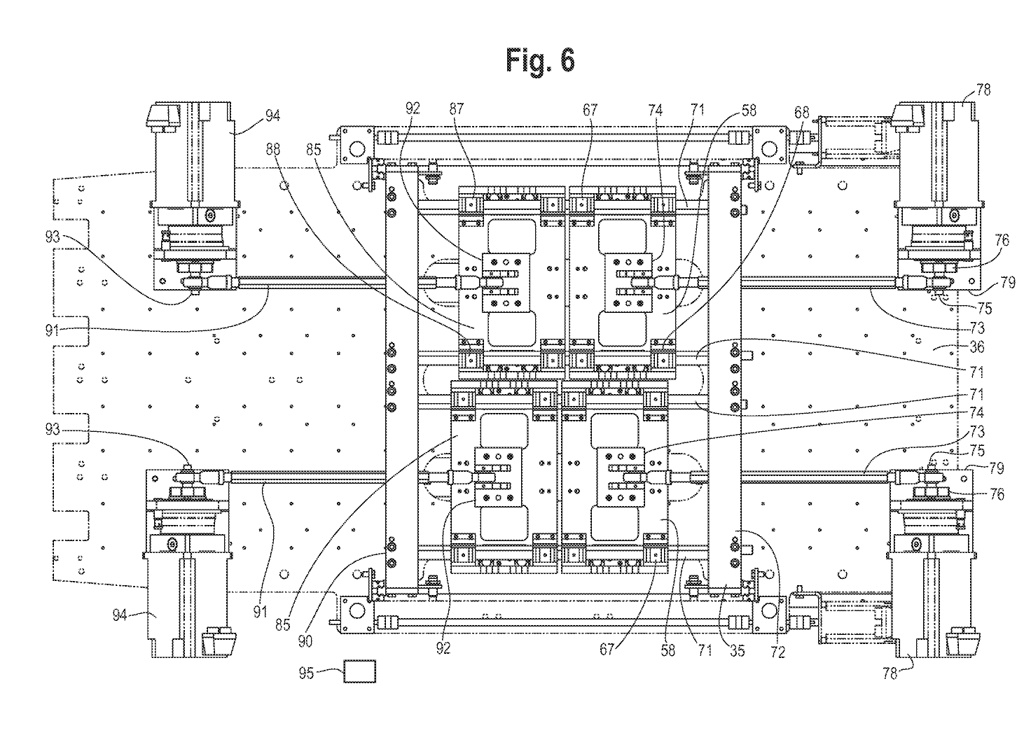

As can be seen in FIG. 6, each pair of upstream product supports 38 is reciprocated over rods 70 and 71 by a connecting rod 73. One end of each rod 73 is connected to a bracket 74 which is attached to the bottom of the mounting plate 58. The other end of the rod 73 is connected to a crank shaft 75 which is mounted on a crank 76. The crank 76 is attached to a planetary gear box 77 which is driven by a servo motor 78. The motor is attached to the frame by a bracket 79.

Referring to FIG. 8, each of the downstream product supports 39 is constructed, slidably supported, and reciprocated in substantially the same way as the upstream supports 38. Each downstream product support includes a pair of adjustable bottom clamps 81 and 82 and a curved top clamp 83. Referring to FIG. 6, the bottom clamps of each of the downstream product supports 39 is mounted on a mounting plate 85 which is similar to the mounting plate 58 and which is positioned below the stationary plate 36. The bottom clamps 81 and 82 are slidably supported by pillow block bearings 87 and 88 which are attached to the mounting plate 85 and which slide over the upper rods 71. The top clamp 83 of each downstream product support is slidably mounted on the lower rods 70 in the same way as the top clamps of the upstream product supports. One side of the top clamp is connected to a side support 89, and pillow block bearings are attached to the side supports and slide over the lower rods 70. Each pair of downstream product supports is reciprocated over the rods 70 and 71 by a connecting rod 91 (FIG. 6) which is attached to a bracket 92 on the mounting plate 85 and to a crank 93 which is driven by a servo motor 94.

Each of the motors 78, 94 can be independently controlled by a processor or programmable logic controller (PLC) 95 or a similar device so that the position of each of the upstream and downstream product supports and the gap between the product supports can be controlled as desired throughout the cutting process. If desired, the motors can be controlled by the same processor which controls the cutting blade so that the longitudinal movement of the product supports can be coordinated with the longitudinal movement of the cutting blade. The manner of controlling such devices is well known to those skilled in the art and need not be explained herein.

The dimension of the gap 40 between the upstream and downstream product supports is also controlled by the motors 78, 94. The dimension of the gap can be varied so that the gap is relatively narrow when cutting an end trim piece and relatively wide when cutting rolls.

As is well known in the art, logs are moved through a log saw by pushers which are mounted on a conveyor. The product supports can move at a rate that is equal to or slower than the product during the cutting process. If the product supports are stationary or move slower than the pushers, the log remains against the pusher and is controlled by the pusher. If the product supports move faster than the product, the product could be pulled downstream away from the pusher. This could be avoided, however, by modifying the conventional hold down shoes of log saws. Hold down shoes are stationary members which are located upstream of the conventional clamps or product supports to apply more pressure on the log to help hold the log against the pusher. If these hold down shoes apply more friction on the log than the movable product supports which are described herein, then the log will remain against the pusher even if the movable product supports move at a greater speed than the pusher.

The gap between the movable product supports can remain constant during the cut or can vary as long as the velocity of the supports is not faster than the product. The upstream and downstream supports do not have to move at the same velocity. The downstream support must be spaced sufficiently from the path of the blade so that the blade does not contact the downstream support. The movement of one or both of the supports can be reversed prior to completion of the cut so long as the supports do not contact the blade.

In the embodiment which is illustrated and described, the upstream product supports for two lanes are driven by one drive, and the downstream product supports for those two lanes are driven by one drive. However, it will be understood that the upstream and downstream product supports for each lane can be driven by a separate drive. Alternatively, the upstream product supports for more than two lanes can be driven by a separate drive and the downstream product supports for more than two lanes can be driven by a separate derive. Moving two lanes at a time is currently preferred because it requires fewer parts than moving each lane individually and moves less mass than would be involved in moving more than two lanes.

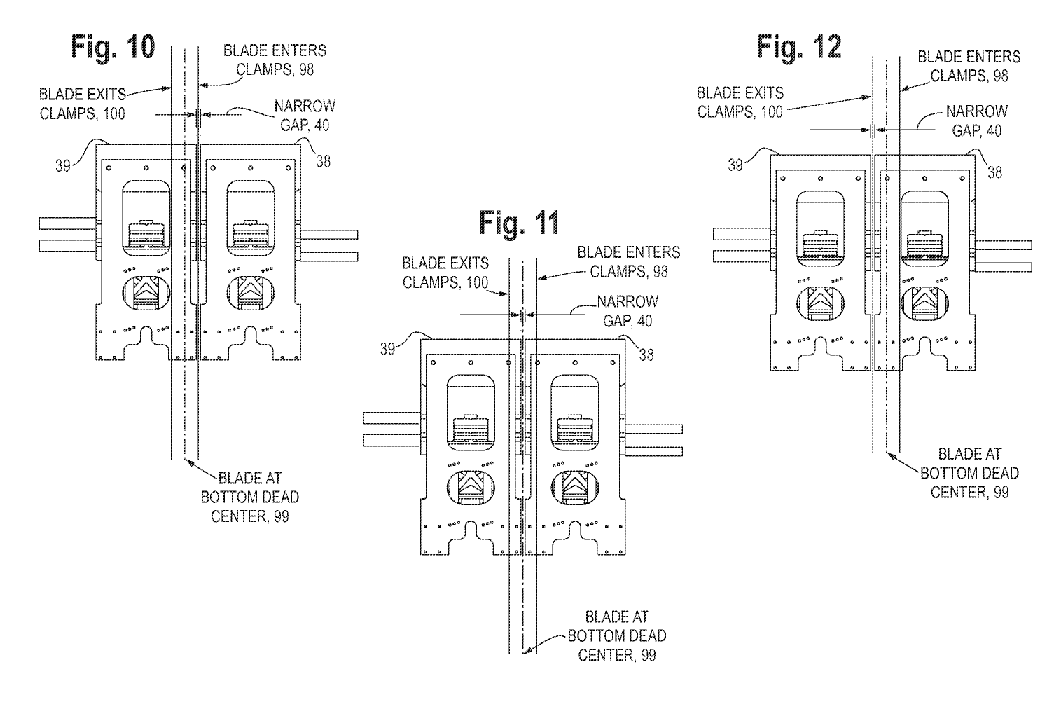

FIGS. 10-12 illustrate one type of movement of the upstream and downstream product supports 38 and 39 when making end trim cuts. When making end trim cuts, it is desirable that the gap 40 between the upstream and downstream product supports is relatively narrow so that the product supports provide good support around the entire product. For example, the gap 40 for end trim cuts having an axial dimension of 0.75 inch can be of the order of about 0.38 inch. As illustrated in FIGS. 4 and 10, the faces of the product supports which define the gap are advantageously parallel to the plane of the cutting blade and parallel to the transverse movement of the cutting blade through the product.

In FIG. 10 the reference line 98 illustrates the position of the cutting blade when the blade enters the gap 40 between the product supports 38 and 39. The cutting blade is advantageously centered in the gap 40. The reference line 99 illustrates the later position of the axially moving cutting blade at its bottom dead center when the cutting blade has reached its farthest downward movement through the product. The reference line 100 illustrates the still later position of the axially moving cutting blade when the blade exits the gap 40.

In FIG. 11 the product supports 38 and 39 have moved longitudinally with the cutting blade so that the cutting blade is substantially centered in the gap 40 at the bottom dead center position 99 of the blade. In FIG. 12 the product supports 38 and 39 have moved farther longitudinally with the cutting blade so that the cutting blade remains substantially centered in the gap as the cutting blade exits the gap. The product supports move continuously during the cutting process. The axial movement of the blade and the product supports as the blade passes through two lanes is about 0.875 inch.

When the product supports for two lanes are connected for common longitudinal movement, the longitudinal movement of the product supports is not reversed until after the blade exits the gap between the product supports for the second lane. In a four lane log saw, when the cutting blade enters the gap between the product supports for the third lane and exits the gap for the second lane, the servo motors for the first two lanes can be operated to reverse the movement of the product supports of the first and second lanes to return those product supports to their original positions to receive the next pass of the cutting blade. Beginning the reverse movement early allows more time for the reverse movement, thereby reducing acceleration stresses. The reverse movement of the product supports causes the product supports to move over the product in the direction which is opposite to the direction of product movement.

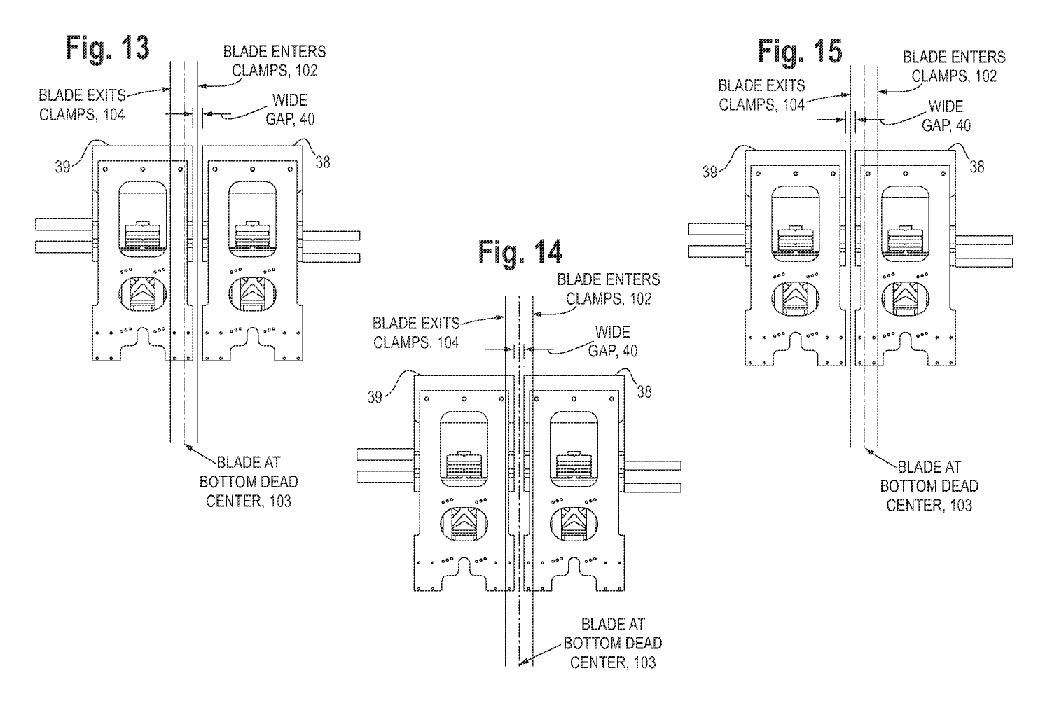

FIGS. 13-15 illustrate one type of movement of the upstream and downstream product supports 38 and 39 when making middle cuts in the log, i.e., cuts other than end trim cuts. The downstream portion of the log being cut is wider (i.e., has a greater axial dimension), and the gap 40 between the product supports can be increased without adversely affecting the support of the product. For example, the gap 40 for middle cuts when product rolls having an axial length of 4.5 inches can be of the order of 1.50 inch.

In FIGS. 13-15 the reference lines 102, 103, and 104 illustrate the position of the cutting blade when the blade enters the gap 40, is at bottom dead center, and exits the gap, respectively. FIGS. 14 and 15 illustrate the axial movement of the product supports with the blade.

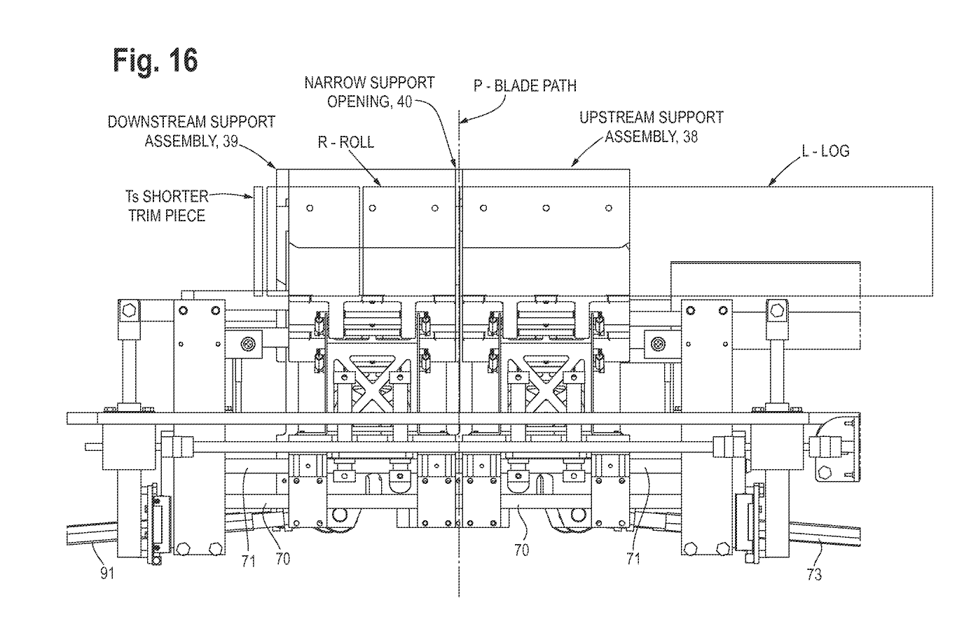

FIG. 16 is a side elevational view of the product support assembly when cutting relatively short end trim pieces Ts. The product supports 38 and 39 are close together to provide a narrow gap 40. An elongated log L is advanced longitudinally through the product support assembly from right to left. The first pass of the cutting blade through the gap 40 produces a short trim piece Ts. Subsequent passes of the cutting blade through the gap produce cut rolls R.

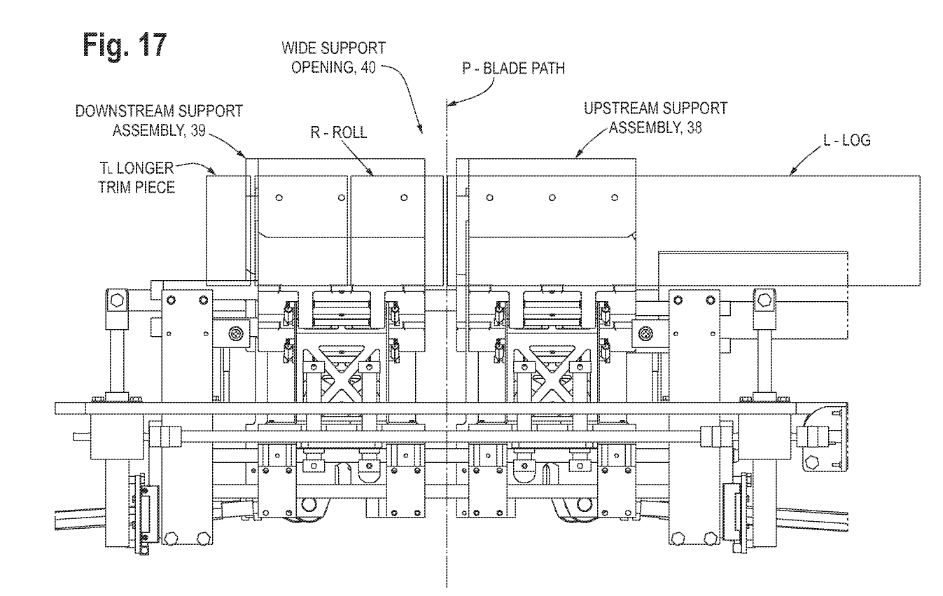

FIG. 17 is a side elevational view similar to FIG. 16 when cutting longer end trim pieces T1. Less support is required for longer end trim pieces, and the gap 40 in FIG. 17 is wider than the gap 40 in FIG. 16. The first pass of the cutting blade produces a longer end trim piece T1.

In FIGS. 16 and 17 the gap 40 remains constant for cutting end trim pieces and for cutting rolls. If desired, however, the gap for cutting rolls can be increased by the servo motors 78, 94 as previously described.

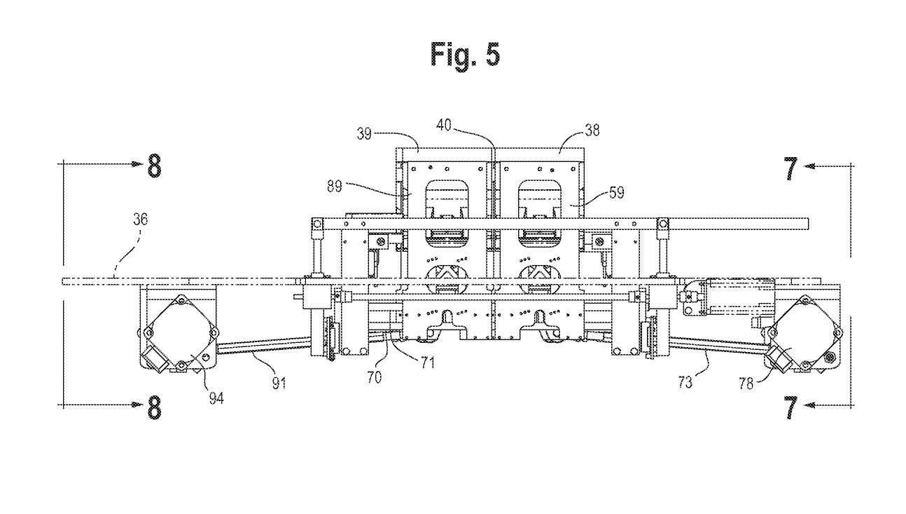

In the preferred embodiment which is illustrated in FIGS. 2-17, the upstream and downstream product supports are moved longitudinally by slidably supporting the product supports for linear longitudinal movement. However, it is possible to move the product supports longitudinally without slidably supporting them for linear longitudinal movement. For example, each of the upstream and downstream product supports could be mounted on a four bar linkage which is pivoted about transverse axes. As each four bar linkage pivots, the associated product support would move both horizontally, i.e., in the longitudinal direction, and vertically.

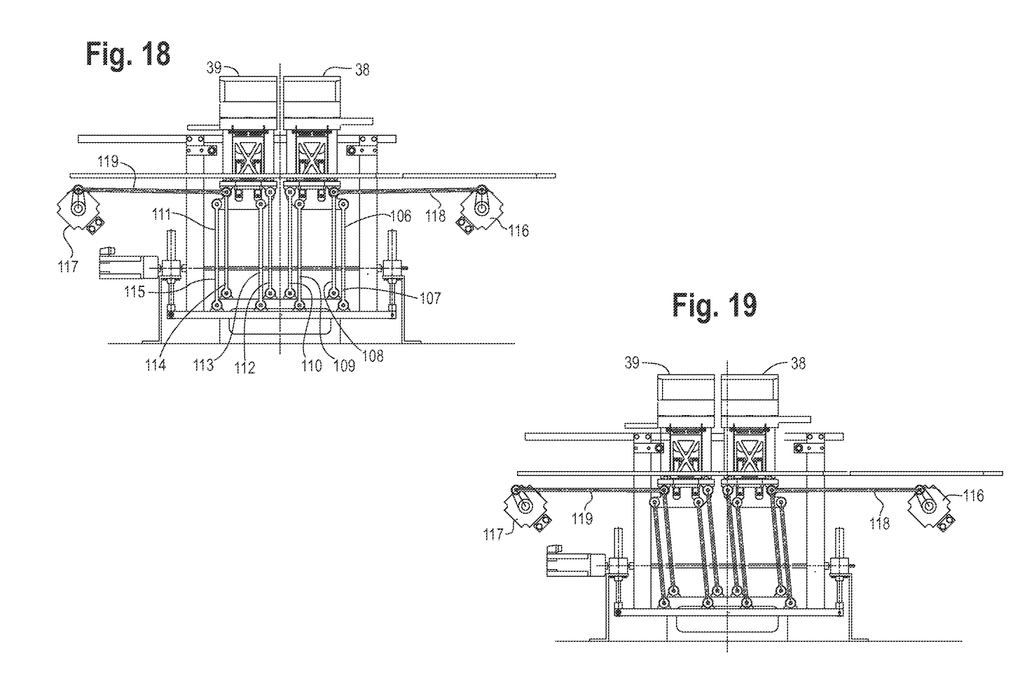

FIGS. 18 and 19 illustrate one type of four bar linkage which is suitable. The upstream product support 38 is mounted on a first four bar linkage 106 which includes four links 107, 108, 109, and 110 which are pivotally connected to the frame and to the product support. The downstream product support 39 is mounted on a second four bar linkage 111 which includes links 112, 113, 114, and 115. The product supports 38 and 39 are independently moved on the four bar linkages by motors 116 and 117, respectively, which are connected to the product supports by links 118 and 119. Pivoting movement of the four bar linkages to the left (FIG. 19) cause the product supports to move longitudinally to the left, and pivoting movement of the four bar linkages to the right cause the product supports to move longitudinally to the right.

Each of the upstream and downstream product supports could also be mounted on a pivot mechanism for pivoting movement about a transverse axis. If the pivot arm is long, the product supports would move in the longitudinal direction with little vertical movement.

Further, the log and the frame which supports the product supports could also be pivotally mounted with respect to the cutting blade.

While in the foregoing specification a detailed description of specific embodiments of the invention has been set forth, it will be understood that many of the details herein given may be varied considerably by those skilled in the art without departing from the spirit and scope of the invention.

We claim:

1. A method of supporting first and second longitudinally moving elongated logs of convolutely wound paper in first and second parallel lanes during cutting comprising the steps of:
a) supporting the first longitudinally moving log in a first lane by first and second supports which are spaced apart in the longitudinal direction of the first log to provide a first gap,
b) supporting the second longitudinally moving log in a second lane by third and fourth supports which are spaced apart in the longitudinal direction of the second log to provide a second gap,
c) moving the first log in a longitudinal direction over the first and second supports and moving the second log in a longitudinal direction over the third and fourth supports,
d) cutting the first longitudinally moving log a first time by passing a cutting blade through the longitudinally moving first log and through said first gap while moving the cutting blade in said longitudinal direction,
e) during the first cutting step of the first log moving at least one of the first and second supports in said longitudinal direction in which the first log is moving,
f) cutting the second longitudinally moving log a first time by passing said cutting blade through the longitudinally moving second log and through said second gap while moving the cutting blade in said longitudinal direction in which the second log is moving,
g) during the first cutting step of the second log moving at least one of the third and fourth supports in said longitudinal direction in which the second log is moving,
h) cutting the first longitudinally moving log a second time by passing a cutting blade through the longitudinally moving first log and through said first gap while moving the cutting blade in said longitudinal direction,
i) during said second cutting step of the first log moving at least one of said first and second supports in said longitudinal direction so that the dimension of said first gap between the first and second supports is different in the second cutting step of the first log than in the first cutting step of the first log,
j) cutting the second longitudinally moving log a second time by passing a cutting blade through the longitudinally moving second log and through said second gap while moving the cutting blade in said longitudinal direction, and
k) during said second cutting step of the second log moving at least one of said third and fourth supports in said longitudinal direction so that the dimension of said second gap between the third and fourth supports is different in the second cutting step of the second log than in the first cutting step of the second log.

2. The method of claim 1 including the steps of reversing the movement of said at least one of the first and second supports between said first and second cutting steps of the first log and reversing the movement of said at least one of the third and fourth supports between said first and second cutting steps of the second log.

3. The method of claim 1 in which one of said cutting steps of the first log produces an end trim piece of said first log, said first gap between the first and second supports being smaller during said one cutting step of the first log than during the other cutting step of the first log and one of said cutting steps of the second log produces an end trim piece of said second log, said second gap between the third and fourth supports being smaller during said one cutting step of the second log than during the other cutting step of the second log.

4. The method of claim 1 in which the first, second, third, and fourth supports are slidably mounted for linear movement in said longitudinal direction.

5. The method of claim 1 in which during one of the cutting steps of the first log both of said first and second supports are moved longitudinally at a slower speed than the first log.

6. The method of claim 1 in which during the one of the cutting steps of the second log both of said third and fourth supports are moved longitudinally at a slower speed than the second log.

7. The method of claim 1 in which the movement of said at least one of the first and second supports during the first cutting step of the first log is reversed before the first cutting step of the first log is completed.

8. The method of claim 1 in which the movement of said at least one of the first and second supports during the first cutting step of the first log is reversed before the first cutting step of the second log is completed.

9. A method of supporting first and second longitudinally moving elongated logs of convolutely wound paper in first and second parallel lanes during cutting comprising the steps of:
a) supporting the first longitudinally moving log in a first lane by first and second supports which are spaced apart in the longitudinal direction of the first log to provide a first gap,
b) supporting the second longitudinally moving log in a second lane by third and fourth supports which are spaced apart in the longitudinal direction of the second log to provide a second gap,
c) moving the first log in a longitudinal direction over the first and second supports and moving the second log in a longitudinal direction over the third and fourth supports,
d) cutting the first longitudinally moving log a first time by passing a cutting blade through the longitudinally moving first log and through said first gap while moving the cutting blade in said longitudinal direction,
e) during the first cutting step of the first log moving both of the first and second supports in said longitudinal direction in which the first log is moving,
f) cutting the second longitudinally moving log a first time by passing said cutting blade through the longitudinally moving second log and through said second gap while moving the cutting blade in said longitudinal direction in which the second log is moving,
g) during the first cutting step of the second log moving both of the third and fourth supports in said longitudinal direction in which the second log is moving,
h) cutting the first longitudinally moving log a second time by passing a cutting blade through the longitudinally moving first log and through said first gap while moving the cutting blade in said longitudinal direction,
i) during said second cutting step of the first log moving both of said first and second supports in said longitudinal direction so that the dimension of said first gap between the first and second supports is different in the second cutting step of the first log than in the first cutting step of the first log,
j) cutting the second longitudinally moving log a second time by passing a cutting blade through the longitudinally moving second log and through said second gap while moving the cutting blade in said longitudinal direction, and
k) during said second cutting step of the second log moving both of said third and fourth supports in said longitudinal direction so that the dimension of said second gap between the third and fourth supports is different in the second cutting step of the second log than in the first cutting step of the second log.

10. The method of claim 9 including the step of reversing the movement of both of said first and second supports between the first and second cutting steps of the first log.

11. The method of claim 9 including the step of reversing the movement of both of said third and fourth supports between the first and second cutting steps of the second log.

12. The method of claim 9 including the step of reversing the movement of both of said first and second supports between the first and second cutting steps of the first log and reversing the movement of both of said third and fourth supports between the first and second cutting steps of the second log.

13. The method of claim 9 in which during both of the cutting steps of the first log both of said first and second supports are moved longitudinally at a slower speed than the first log and during both of the cutting steps of the second log both of said third and fourth supports are moved longitudinally at a slower speed than the second log.
